(19) United States
(12) Patent Application Publication
(10) Pub. No.: US 2018/0264593 A1
(43) Pub. Date: Sep. 20, 2018

(54) MODULAR LASER DEVICE

(71) Applicant: SAINT-GOBAIN GLASS FRANCE, Courbevoie (FR)

(72) Inventors: Brice DUBOST, Courbevoie (FR); Emmanuel MIMOUN, Boulogne-billancourt (FR); Lorenzo CANOVA, Paris (FR); Nicolas DESBOEUFS, Compiegne (FR)

(21) Appl. No.: 15/754,869

(22) PCT Filed: Aug. 23, 2016
(86) PCT No.: PCT/FR2016/052104

§ 371 Date: Feb. 23, 2018

(30) Foreign Application Priority Data
Aug. 25, 2015 (FR) 1557907

(51) Int. Cl. B23K 26/073; B23K 26/06; B23K 26/08; G02B 27/09; B23K 26/359

(52) U.S. Cl. CPC B23K 26/0738; B23K 26/0608; B23K 2203/52; G02B 27/0905; B23K 26/359; B23K 26/0838

(57) ABSTRACT

The present invention relates to a laser device for annealing coatings deposited on large-width substrates, said device being formed from a plurality of laser modules that may be juxtaposed without particular limitation, wherein the laser modules generate elementary laser lines that combine with one another in the length direction to form a single laser line, each elementary line having an overlap in the length direction with one or two adjacent elementary laser lines; and at least two adjacent elementary laser lines have an offset with respect to one another in the width direction, said offset being smaller than half the sum of the widths of said at least two adjacent elementary laser lines; the overlap of said at least two adjacent elementary laser lines is such that, in the absence of offset, the power-per-unit-length profile of the single laser line has a local maximum level with the zone of overlap.

The present invention relates to a laser device for annealing coatings deposited on large-width substrates, which device is formed from a plurality of laser modules that may be juxtaposed without particular limitation.

It is known to carry out laser flash heating of coatings deposited on flat substrates. To do this, the substrate with the coating to be heated is run under a laser line, or indeed a laser line is run over the substrate bearing the coating.

Laser flash heating allows thin coatings to be heated to high temperatures, of the order of several hundreds of degrees, while preserving the subjacent substrate. Run speeds are of course preferably as high as possible, and advantageously at least several meters per minute.

In order to be able to treat at high speeds substrates of large width, such as “jumbo” sized (6 m×3.21 m) flat glass sheets obtained via float processes, it is necessary to have at one's disposal laser lines that are themselves very long (>3 m). However, the manufacture of monolithic lenses allowing a single laser line to be obtained is not envisionable for such lengths. Modular laser devices have therefore been envisioned, in which it is proposed to combine elementary laser lines of smaller size (a few tens of centimeters) each generated by independent laser modules.

A first way of combining the elementary laser lines consists in placing them in separate rows, which are for example staggered or arranged in a “V formation”, so that there are no zones of overlap between the elementary laser lines, in such a way as to allow the entire width of the substrate to be treated. Thus, each of the points on the width of the substrate passes at least once under one elementary laser line. This solution is relatively simple to implement, in particular because it imposes few constraints on the bulk of the laser modules. However, this solution is a source of nonuniformity. Specifically, certain points of the substrate undergo two treatments, possibly with different powers, because they pass in succession under two elementary laser lines. This generally results in defects in the treated substrate.

Another solution consists in exactly aligning the elementary laser lines with one another and in partially superposing them in the length direction while choosing the power-per-unit-length profiles of the elementary laser lines such that they add to form a uniform line (i.e. a line with a constant width and a constant power-per-unit-length profile over the entire length of the line). Provision is generally made for the profiles of linear power per unit length of the elementary laser lines to be top-hat shaped with a very broad central plateau in which the power is high and constant and, on either side of this plateau, steep-sloped descending flanks, as for example in U.S. Pat. No. 6,717,105. The choice of this type of profile allows the zone of overlap between two adjacent elementary laser lines to be minimized, but requires the elementary laser lines to be positioned very precisely. WO 2015/059388 proposes to decrease the extent of the high-power central plateau of the elementary laser lines. Thus, the slope of the two flanks of the power profile of the elementary laser lines is less steep. This makes it possible to mitigate the repercussions of an error made positioning the elementary laser lines on the density profile of the laser line obtained by combining the elementary laser lines. However, it is very difficult in practice to obtain elementary laser lines having exactly the desired power profile. More particularly, it is difficult to obtain elementary laser lines having power profiles that are sufficiently identical to one another, in particular level with the slopes of the flanks of the power profiles. In practice, the intensity gradient of the flanks of the power profiles varies from one elementary laser line to the next. These differences in power profiles between the elementary laser lines means that the elementary laser lines are not perfectly complementary with one another. This leads to powers that are undesirably high and/or low level with the zones of overlap between the elementary laser lines and to a nonuniformity in the treatment of the portions of the substrate that pass under these zones of overlap with respect to the rest of the substrate. For certain coatings, this treatment nonuniformity is enough to generate visible defects in the final product.

The present invention provides a new way of combining elementary laser lines that allows a better treatment uniformity to be guaranteed in the zones of overlap of the elementary laser lines. More precisely, the present invention relates to a laser device comprising:

a plurality of laser modules each generating an elementary laser line of length L and of width W and that is focused level with a working plane; and
conveying means intended to receive a substrate;
in which said laser modules are positioned so that the generated elementary laser lines are substantially parallel to one another and combine into a single laser line, each elementary line having an overlap in the length direction with an adjacent elementary laser line; and
the conveying means allow the substrate to be run perpendicularly to the single laser line;
characterized in that, for at least two adjacent elementary laser lines, the two adjacent elementary laser lines have an offset with respect to one another in the width direction, said offset being smaller than half the sum of the widths of said two adjacent elementary laser lines; the overlap of said two adjacent elementary laser lines being such that, in the absence of offset, the power-per-unit-length profile of the single laser line has a local maximum level with the zone of overlap.

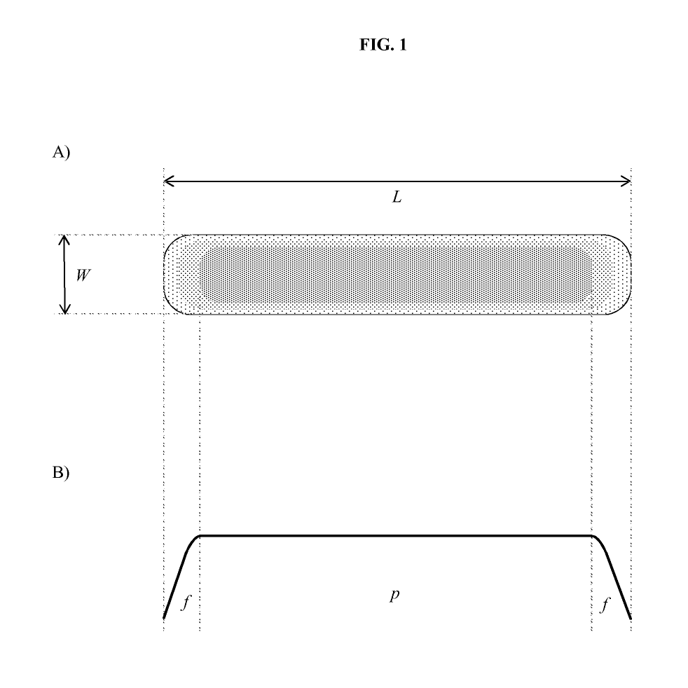

FIG. 1 shows an example of an elementary laser line (A) and its corresponding power profile (B).

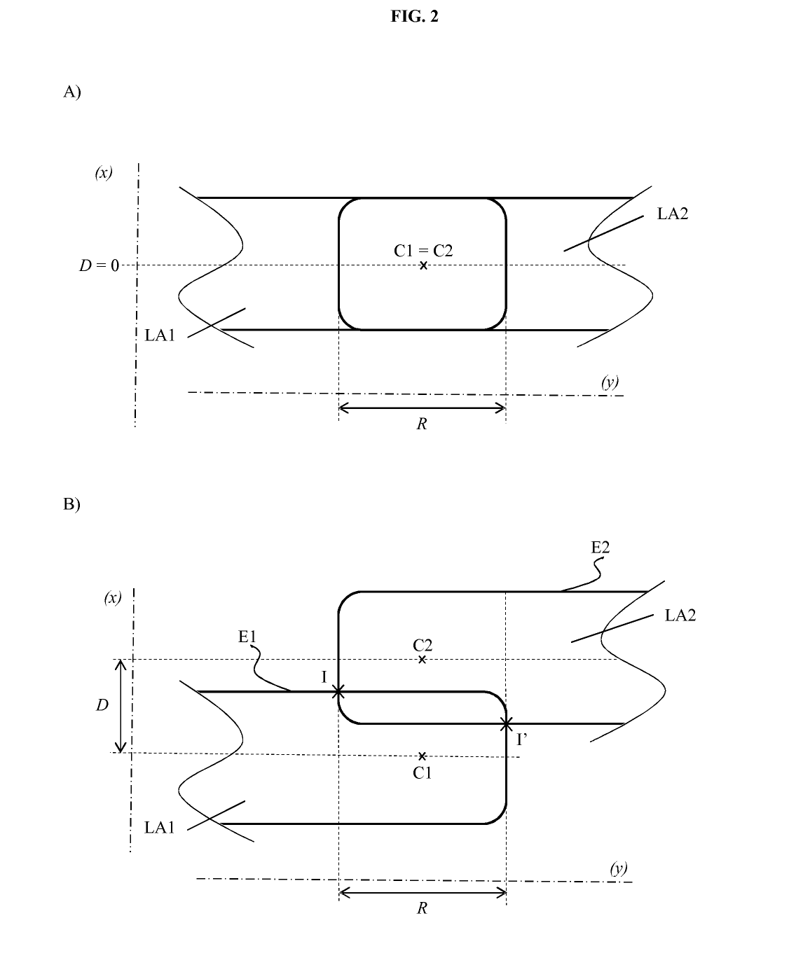

FIG. 2 shows examples of zones of overlap between two elementary laser lines without offset (A) and with offset (B).

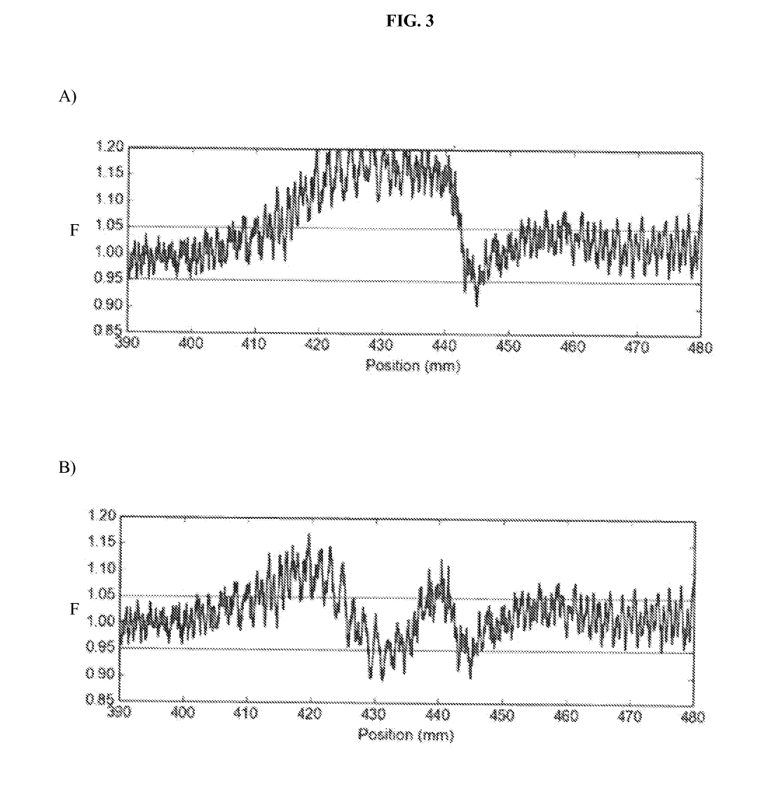

FIG. 3 shows examples of plots of the figure of merit level with the zone of overlap of two elementary laser lines without offset (A) and with offset (B).

Contrary to the prior art, it is not sought in the present invention to perfectly align the elementary laser lines with one another in order to make the power profiles of the theoretically identical elementary laser lines correspond with one another. Specifically, the Applicant has found that the uniformity of the treatment may be improved by offsetting adjacent elementary laser lines so as thus to create, locally, an increase in the width of the single laser line level with the zones of overlap between these adjacent elementary laser lines. This approach goes against the prejudices of those skilled in the art who, to improve the uniformity of the treatment, seek to ensure that all the points of the substrate undergo the same treatment, and in particular are treated for the same length of time. In contrast, widening the line in certain zones of overlap increases the duration of treatment of the portions of the substrate passing under these zones. Surprisingly however, widening the single laser line level with the zones of overlap allows the uniformity of the treatment to be improved despite the increase in the duration of the treatment. Specifically, it would appear that spreading, over a longer lapse of time, the application of the undesirably high powers caused by the overlap of the power profiles of two adjacent elementary laser lines that are not perfectly complementary improves the uniformity of the treatment.

More particularly, increasing the width of the single laser line level with the zones of overlap allows, level with the zones of overlap, the variation in a figure of merit F, defined in the present application as being the ratio of the power per unit length over the square root of the width of the line, to be decreased. Specifically, the Applicant has demonstrated that the uniformity of a heat treatment with a single laser line may be correlated to the uniformity of the figure of merit F. The figure of merit F at a point of a laser line is given by the following formula:

$$F = \frac{P}{\sqrt{w}}$$

in which w and P are the width of the laser line at this given point and the (cumulative i.e. over the entire width of the line) local power per unit length of the laser line at this given point, respectively.

The expression “at a given point” of a laser line is understood in the present invention to mean “at a given position” along the laser line. In other words, a point of the laser line is considered equivalent to a position on the longitudinal axis x of the laser line (i.e. in the working plane and perpendicular to the run direction).

In the context of the present invention, the expression “local power per unit length” P at a given point of a laser line is understood to mean the power delivered by the module to the entire width of the laser line at this given point. By “width at a given point” w of a laser line, what is meant is the dimension, measured at this given point in the transverse direction y of the laser line (i.e. parallelly to the run direction), of a zone receiving a power at least equal to 1/e² times the maximum power of the laser line. If the longitudinal axis is denoted x, it is possible to define a width distribution along this axis, denoted w(x).

The laser device preferably comprises at least 3 modules, in particular at least 5 modules, or even at least 10 modules, each laser module generating an elementary laser line that is focused level with the working plane, which corresponds to the plane of the coating to be heated, i.e. generally to the upper or lower surface of the substrate. The laser modules are assembled and mounted in the laser device so that the laser beams forming the laser lines cut the working plane with a nonzero angle with respect to the normal to the working plane, this angle typically being larger than 2° and smaller than 20°, and preferably smaller than 10°.

As illustrated in FIG. 1A, each elementary laser line has a length L and a width W. By the “length” L of a laser line, what is meant is the dimension, measured in the longitudinal direction x, of a zone receiving a power at least equal to 1/e² times the maximum power of the laser line. The “average width” W of a laser line, also simply called the “width” of a laser line in contrast to the width at a point w of the laser line, is defined as the arithmetic mean of the widths at each of the points of the laser line. In order to avoid any treatment nonuniformity, the width distribution w(x) is narrow the entire length of a line. Thus, the variation in the width distribution w(x) along the laser line varies by no more than 10%, preferably by no more than 5%, and more preferably by no more than 3%, with respect to the average width of the laser line. The elementary laser lines generally have substantially identical lengths and widths. The elementary laser lines typically have a length of 10 to 100 cm, preferably of 20 to 75 cm, and more preferably of 30 to 60 cm, and a width of 10 to 100 μm, and preferably of 40 to 75 μm.

Considered independently, the elementary laser lines typically have a power-per-unit-length profile comprising a central plateau p and two lateral flanks f such as schematically illustrated in FIG. 1B. In the context of the present invention, the expression “power-per-unit-length profile” when applied to a laser line is understood to mean the distribution, over the entire length of the laser line, of the local power per unit length P as a function of position in the laser line. Since the longitudinal axis is denoted x, the power-per-unit-length profile is therefore defined as P(x). The central plateau has a substantially constant power, and each lateral flank corresponds to a power gradient. The central plateau generally represents at least 50%, preferably 70 to 98%, and more preferably 80 to 96%, of the length of the elementary laser line. The width of an elementary laser line is substantially constant along the central plateau. The expression “substantially constant” is understood to mean that the quantity in question varies by no more than 10%, preferably by no more than 5%, and more preferably by no more than 3%. The lateral flanks generally each represent independently less than 25%, preferably 1 to 15%, and more preferably 2 to 10% of the length of the elementary laser line. The lateral flanks preferably have substantially the same length.

The elementary laser lines are placed end-to-end in the direction of their lengths so as to form a continuous single laser line. The single laser line typically has a length larger than 1.2 m, preferably larger than 2 m, and more preferably larger than 3 m. By “continuous laser line”, what is meant is that there exists a path running from one end of the single laser line to the other on which the power is never lower than 90% of the maximum power of the single laser line. To achieve this, two adjacent elementary laser lines overlap in a zone of overlap. By “zone of overlap” what is meant is a zone in which two adjacent elementary lines superpose. The term “overlap” R is understood to mean the dimension of the zone of overlap measured in projection on the longitudinal axis x. The offset is defined with respect to a reference position in which the elementary laser lines are exactly aligned. As illustrated in FIG. 2A, two adjacent elementary laser lines LA1 and LA2 are considered to be exactly aligned when, level with the zone of overlap between the two adjacent elementary laser lines, the intensity distributions C1 and C2 of the two elementary laser lines have centroids that have an identical coordinate in projection on the transverse axis y. Thus, the “offset” D between two adjacent elementary laser lines is defined as the distance between the projections, on the transverse axis y, of the centroids of the powers of the ends of the two adjacent elementary laser lines participating in the zone of overlap between these two lines. An intensity-distribution centroid is defined as the point having as coordinates the average, weighted by the value of the intensity distributions, of the coordinates of all of the points in the zone in question. In practice, for two adjacent elementary laser lines offset as illustrated in FIG. 2B, it is possible to define for each of the elementary lines LA1 and LA2 an enveloping line E1 and E2, respectively, defined by the outline of the zone having a power at least equal to 1/e² times the maximum power of the laser line. The enveloping lines then have two points of intersection I and I′. The overlap R may be defined as the distance between the projections of the points I and I′ on the longitudinal axis x. The offset D may be defined as the difference between the half-sum of the average widths of the adjacent elementary laser lines and the distance between the projections of the points I and I′ on the transverse axis y.

The overlap between two adjacent elementary laser lines is generally at least equal to the shortest of the lateral flanks of said two adjacent elementary laser lines level with the zone of overlap. Thus, the overlap is generally equal to less than 25%, preferably 1 to 15%, and more preferably 2 to 10% of the length of each of the elementary laser lines. In one preferred embodiment, the lateral flanks of the elementary laser lines all have substantially the same length and the overlap is substantially equal to the length of the lateral flanks.

In the present invention, at least two adjacent elementary laser lines have a nonzero offset that is preferably larger than 10%, and more preferably larger than 25% of the width of each of said adjacent elementary laser lines. Said at least two adjacent elementary laser lines furthermore have an overlap such that, in the absence of offset, the power-per-unit-length profile of the single laser line has a local maximum level with the zone of overlap. In other words, said at least two adjacent elementary laser lines have power-per-unit-length profiles the lateral flanks of which are not exactly complementary. Said local maximum in the power-per-unit-length profile of the single laser line preferably has a value that is higher by 20%, and more preferably higher by 10%, with respect to the average power per unit length of each of the adjacent elementary laser lines outside of the zones of overlap. The offset and overlap of said at least two adjacent elementary laser lines are preferably such that the figure of merit F of the single laser line level with the zone of overlap varies by less than 20%, preferably by less than 15%, more preferably by less than 10%, and even more preferably by less than 5% with respect to the average figure of merit of each of said at least two adjacent elementary laser lines outside of the zones of overlap. In the case of elementary laser lines having a power and a width that are substantially constant level with the central plateau of the power-per-unit-length profile, the average power per unit length and the average figure of merit outside of the zones of overlap may be considered equivalent to the average power per unit length and to the average figure of merit on the central plateau of the power-per-unit-length profile.

The conveying means are intended to receive a substrate and to allow the substrate to be run perpendicularly to the single laser line. What is important is for it to be possible to move the substrate and the single laser line relative to each other; the device may be designed so that the substrate remains stationary and the laser modules are moved above or below the substrate, or vice versa. However, from the industrial point of view, in particular as regards the treatment of substrates of large size such as “jumbo” substrates, it is preferable for the laser modules to be stationary and the substrate to be treated to be run below or above the modules. The substrate may be made to move using any mechanical conveying means, for example using belts, rollers or trays providing a translational movement. The conveying system allows the speed of the movement to be controlled and adjusted. The conveying means preferably comprises a rigid chassis and a plurality of rollers. The pitch of the rollers is advantageously comprised in a range extending from 50 to 300 mm. The rollers preferably comprise metal rings, typically made of steel, covered with plastic covers. The rollers are preferably mounted on low-play end bearings, with typically three rollers per end bearing. In order to ensure the plane of conveyance is perfectly planar, the position of each of the rollers is advantageously adjustable. The rollers are preferably moved using pinions or chains, preferably tangential chains, driven by at least one motor. If the substrate is made of a flexible organic polymer, the movement may be generated using a film advance system taking the form of a succession of rollers. In this case, planarity may be ensured via a suitable choice of the distance between the rollers, taking into account the thickness of the substrate (and therefore its flexibility) and any effect that the heat treatment may have as regards the possible creation of bow.

The present invention also relates to a method for adjusting a laser device comprising:

a plurality of laser modules each generating an elementary laser line of length L and of width W and that is focused level with a working plane; and conveying means intended to receive a substrate;
in which said laser modules are positioned so that the generated elementary laser lines are substantially parallel to one another and combine in the length direction into a single laser line; and
the conveying means allow the substrate to be run perpendicularly to the single laser line; said method comprising:
measuring the power-per-unit-length profiles and the widths of two adjacent elementary laser lines individually;
determining an overlap-offset pair such that the figure of merit F of the single laser line level with the zone of overlap varies by less than 20%, preferably by less than 15%, and more preferably by less than 10%, with respect to the average figure of merit of each of said two adjacent elementary laser lines outside of the zone of overlap; and
positioning the laser modules corresponding to said two adjacent elementary laser lines so that said two adjacent elementary laser lines have the determined overlap-offset pair.

The power-per-unit-length profiles of each of the elementary laser lines are measured separately level with the working plane. They may be measured by placing a power detector along the laser line, for example a calorimetric power meter, such as in particular the Beam Finder power meter from the company Coherent Inc., or a laser-beam-analyzing system using a video camera, such as the system FM 100 from the company Métrolux GmbH. A laser-beam-analyzing system has the advantage of allowing the widths of the laser lines to be measured at the same time. From the measured profiles, it is possible to determine, by simulation, for an overlap and a given offset between two elementary laser lines, the profile of the figure of merit F level with the zone of overlap. Thus, by scanning the overlap-offset pairs in increments of suitable size, said pairs may be chosen, for example using a suitable software package, so that the figure of merit F meets the aforementioned conditions. Ideally, the overlap-offset pair for which the variation in the figure of merit is minimal will be chosen. However, it is not absolutely essential for the variation to be minimal, simply decreasing the variation in the figure of merit so that this variation is smaller than 20% with respect to the average figure of merit of each of said two adjacent elementary laser lines outside of the zone of overlap alone allows the uniformity of the treatment to be improved satisfactorily for most coatings to be treated.

In one preferred embodiment in which the laser device comprises n laser modules generating n elementary laser lines, n being strictly higher than 2, it is also possible to furthermore determine which combination of elementary laser lines and overlap-offset pairs is liable to minimize the variation in the figure of merit. Specifically, since each of the elementary laser lines does not have strictly the same linear power profile, in particular level with the lateral flanks, the profile of the single line also depends on the order in which the elementary laser lines are combined. For example, with three elementary lines A, B and C, the various elementary-laser-line juxtaposition combinations ABC, ACB, BAC, BCA, CAB and CBA do not necessarily yield, even after optimization of the overlap-offset pairs, identical figure-of-merit profiles. Thus, the adjusting method according to the invention preferably comprises:
measuring the power-per-unit-length profiles of each of the n elementary laser lines individually;
determining a juxtaposition combination of the n elementary laser lines and, for each pair of adjacent laser lines, an overlap-offset pair such that the figure of merit F of the single laser line level with the zones of overlap varies by less than 20%, preferably less than 15%, and more preferably less than 10% with respect to the average figure of merit of each of said elementary laser lines outside of the zones of overlap; and
positioning the laser modules corresponding to the elementary laser lines so that said elementary laser lines are in the determined juxtaposition combination and each pair of adjacent elementary laser lines has the determined overlap and offset.

It will be understood that a plurality of elementary-laser-line juxtaposition combinations, with a suitable choice of the overlap-offset pairs for each pair of adjacent elementary laser lines, may allow the aforementioned conditions on the figure of merit F to be met, or even the variation in the figure of merit to be minimized.

The laser device of the present invention is suitable for heat treating coatings deposited on the surface of a substrate. Another subject of the present invention is the use of the laser device such as described above to heat treat a coating deposited on a substrate.

The present invention also relates to a method for heat treating a coating deposited on a substrate using the laser device such as defined above, comprising:
providing the substrate coated with the coating to be treated on the conveying means so that the coating is level with the working plane;
running the substrate perpendicularly to the single laser line; and
collecting the substrate coated with the heat treated coating.

Alternatively, the method for heat treating a coating deposited on a substrate comprises:
providing a laser device such as defined in the above adjusting method;
adjusting the laser device using the above adjusting method;
providing the substrate coated with the coating to be treated on the conveying means so that the coating is level with the working plane;
running the substrate perpendicularly to the single laser line;
collecting the substrate coated with the heat treated coating.

The substrate may be an organic or inorganic substrate. The substrate is preferably made of glass, glass-ceramic or of a polymeric organic material. It is preferably transparent, untinted (it is then a question of a clear or extra-clear glass) or tinted, for example blue, gray, green or bronze. The glass is preferably soda-lime-silica glass, but it may also be borosilicate or alumino-borosilicate glass. Preferred organic polymeric materials are polycarbonate, polymethyl methacrylate, polyethylene terephthalate (PET), polyethylene naphthalate (PEN), or even fluoropolymers such as ethylene tetrafluoroethylene (ETFE). The substrate advantageously possesses at least one dimension that is larger than or equal to 1 m or even 2 m and even 3 m in size. The thickness of the substrate generally varies between 0.5 and 19 mm, preferably between 0.7 and 9 mm, in particular between 2 and 8 mm, or even between 4 and 6 mm. The substrate may be planar or curved, or even flexible.

The coating preferably comprises a layer at least one property of which is improved when the degree of crystallization of said layer increases. The layer is preferably based on a metal, oxide, nitride, or mixed oxides chosen from silver; titanium; molybdenum; niobium; titanium oxide; mixed oxides of indium and zinc or tin; aluminum- or gallium-doped zinc oxide; titanium, aluminum or zirconium nitride; niobium-doped titanium oxide; cadmium and/or tin stannate; and fluorine- and/or antimony-doped tin oxide. The present invention is particularly adapted to coatings comprising a silver- or titanium-based layer, the latter being more sensitive to nonuniformities in the heat treatment. The expression “-based” when used to refer to the composition of a layer means that said layer comprises more than 80%, preferably more than 90%, and more preferably more than 95% by weight of the material in question. The layer may essentially consist of said material, i.e. comprise more than 99% by weight of said material.

The substrate is positioned on the conveying means so that the coating is level with the working plane. In other words, the substrate is positioned so that the elementary laser lines are focused level with the coating to be treated. The run speed of the substrate with respect to the laser line of course depends on the nature of the coating to be treated, on its thickness but also on the power of the laser lines. By way of indication, the run speed is advantageously at least 4 m/min, in particular 5 m/min and even 6 m/min or 7 m/min, or indeed 8 m/min and even 9 m/min or 10 m/min. According to certain embodiments, the speed of movement of the substrate is at least 12 m/min or 15 m/min, in particular 20 m/min and even 25 or 30 m/min. In order to ensure the treatment is as uniform as possible, the speed of movement of the substrate varies during the treatment by at most 10 rel %, in particular 2 rel % and even 1 rel % with respect to its nominal value.

The invention is illustrated by way of the following nonlimiting examples.

### EXAMPLE

A laser device is equipped with two laser modules each generating an elementary laser line of 40 cm length and 65 μm width and the power-per-unit-length profiles of which comprise a central plateau and two lateral flanks, with a power per unit length of 250 W/cm level with the plateau.

Two samples S1 and S2 of a substrate made of float soda-lime-silica glass sold under the trade name Planiclear® by the Applicant, of 80 cm×80 cm size and coated with a PLANITHERM® coating comprising a silver layer, were subjected to a heat treatment by passing them, at a run speed of 3 m/s, under a single laser line formed by the two elementary laser lines.

For the treatment of the sample S1, the two elementary laser lines were combined with an overlap of 20 mm and a zero offset. The single laser line thus formed had a constant

$$F = \frac{P}{\sqrt{w}}$$

width. The profile of the figure of merit of the single laser line level with the zone of overlap of the two elementary laser lines is shown in FIG. 3A. For the sake of readability, the figure of merit has been normalized by the average figure of merit outside of the zone of overlap. It may be seen that the figure of merit has a maximum that is higher by more than 20% with respect to the average figure of merit outside of the zone of overlap.

For the treatment of the sample S2, the two elementary laser lines were combined with an overlap that was identical to the treatment of S1 (20 mm) and with an offset of 60 μm. The single laser line thus had a larger width (100 μm) level with the zone of overlap with

$$F = \frac{P}{\sqrt{w}}$$

respect to the zones outside of the overlap. The profile of the figure of merit of the single laser line level with the zone of overlap of the two elementary laser lines is shown in FIG. 3B. It may be seen that the figure of merit varies by no more than 15% with respect to the average figure of merit outside of the zone of overlap.

After treatment, the samples were observed by the naked eye under an artificial sky. The sample S1 had a mark that was visible to the naked eye level with the zone of the substrate corresponding to passage under the zone of overlap of the elementary laser lines. In contrast, the sample S2 appeared uniform. Offsetting the two elementary laser lines therefore allows defects caused by a treatment nonuniformity level with the overlap of two elementary laser lines to be satisfactorily decreased.

1. A laser device comprising:
a plurality of laser modules each generating an elementary laser line of length (L) and of width (W) and that is focused level with a working plane; and
conveying means intended to receive a substrate;
in which said laser modules are positioned so that the generated elementary laser lines are substantially parallel to one another and combine into a single laser line, each elementary line having an overlap (R) in the length direction with an adjacent elementary laser lines; and
the conveying means allow the substrate to be run perpendicularly to the single laser line;
characterized in that, for at least two adjacent elementary laser lines (LA1, LA2), the elementary laser lines have an offset (D) with respect to one another in the width direction, said offset being smaller than half the sum of the widths of said two adjacent elementary laser lines; the overlap (R) of said at least two adjacent elementary laser lines (LA1, LA2) being such that, in the absence of offset, the power-per-unit-length profile of the single laser line has a local maximum level with the zone of overlap.

2. The device as claimed in claim 1, characterized in that said local maximum in the power-per-unit-length profile of the single laser line has a value that is higher by 20%, and preferably higher by 10%, with respect to the average power per unit length of each of said at least two adjacent elementary laser lines (LA1, LA2) outside of the zone of overlap.

3. The device as claimed in claim 1 or 2, characterized in that said offset (D) is chosen so that level with the overlap the figure of merit F of the single laser line varies by less than 20%, preferably by less than 15%, more preferably by less than 10%, and even more preferably by less than 5%, with respect to the average figure of merit of each of said at least two adjacent elementary laser lines (LA1, LA2) outside of the zone of overlap;
the figure of merit F at a given point of a laser line being defined by:
$$F = \frac{P}{\sqrt{w}}$$
in which w and P are the width and local power per unit length of the laser line at this given point, respectively.

4. The laser device as claimed in any one of claims 1 to 3, characterized in that said offset (D) is larger than 10% of the width of each of said at least two adjacent elementary laser lines (LA1, LA2).

5. The device as claimed in any one of claims 1 to 4, characterized in that the power-per-unit-length profiles of the elementary laser lines contain a central plateau (p) and two lateral flanks (f), the central plateau (p) having a substantially constant power per unit length, and the power per unit length of each lateral flank (f) having a gradient.

6. The device as claimed in claim 5, characterized in that the overlap (R) between two adjacent elementary laser lines (LA1, LA2) is at least equal to the length of the shortest of the lateral flanks (f) of said two adjacent elementary laser lines (LA1, LA2) level with the zone of overlap.

7. A method for adjusting a laser device comprising
a plurality of laser modules each generating an elementary laser line of length (L) and of width (W) and that is focused level with a working plane; and
conveying means intended to receive a substrate;
in which said laser modules are positioned so that the generated elementary laser lines are substantially parallel to one another and combine in the length direction into a single laser line; and
the conveying means allow the substrate to be run perpendicularly to the single laser line;
said method comprising:
measuring the power-per-unit-length profiles and the widths of two adjacent elementary laser lines (LA1, LA2) individually;
determining an overlap-offset pair (R, D) such that the figure of merit F of the single laser line level with the zone of overlap varies by less than 20%, preferably by less than 15%, more preferably by less than 10%, and even more preferably by less than 5%, with respect to the average figure of merit of each of said two adjacent elementary laser lines (LA1, LA2) outside of the zone of overlap;
the figure of merit F at a given point of a laser line being defined by:
$$F = \frac{P}{\sqrt{w}}$$
in which w and P are the width and local power per unit length of the laser line at this given point, respectively; and
positioning the laser modules corresponding to said two adjacent elementary laser lines (LA1, LA2) so that said two adjacent elementary laser lines have the determined overlap-offset pair.

8. The use of the laser device such as defined in any one of claims 1 to 6 to heat treat a coating deposited on a substrate.

9. A method for heat treating a coating deposited on a substrate comprising:
providing a laser device such as defined in claim 7;
adjusting the laser device using the adjusting method of claim 7;
providing the substrate coated with the coating to be treated on the conveying means so that the coating is level with the working plane;
running the substrate perpendicularly to the single laser line;
collecting the substrate coated with the heat treated coating.
